(19) United States
(12) Patent Application Publication
(10) Pub. No.: US 2014/0064229 A1
(43) Pub. Date: Mar. 6, 2014

(54) METHOD AND APPARATUS FOR TRANSMITTING DISCOVERY SIGNAL IN WIRELESS COMMUNICATION SYSTEM

(71) Applicants: Wookbong Lee, Anyang-si (KR); Inuk Jung, Anyang-si (KR); Jinsam Kwak, Anyang-si (KR); Kiseon Ryu, San Diego, CA (US)

(72) Inventors: Wookbong Lee, Anyang-si (KR); Inuk Jung, Anyang-si (KR); Jinsam Kwak, Anyang-si (KR); Kiseon Ryu, San Diego, CA (US)

(73) Assignee: LG ELECTRONICS INC., Seoul (KR)

(21) Appl. No.: 14/112,818

(22) PCT Filed: Apr. 19, 2012
(86) PCT No.: PCT/KR2012/002970

§ 371 Date: Nov. 18, 2013

Related U.S. Application Data
(60) Provisional application No. 61/476,769, filed on Apr. 19, 2011.

(51) Int. Cl. H04W 48/16; H04W 72/04

(52) U.S. Cl. CPC H04W 48/16; H04W 72/04
USPC 370/329

(57) ABSTRACT

The present invention relates to a wireless communication system, and more specifically to a method and an apparatus for transmitting a discovery signal in a wireless communication system. According to one aspect of the present invention, a method for enabling a terminal for supporting multiple radio access technologies to perform communication includes the steps of: communicating first data to a base station; receiving first information for notifying the presence of a first AP from the first AP as at least one AP among a plurality of APs; and communicating second data using the first AP, wherein the first information is received by using a first resource as at least a part of all resources which the base station uses, a first radio access technology can be applied between the terminal and the base station, and a second radio access technology can be applied between the terminal and the first AP.

### TECHNICAL FIELD

The present invention relates to a wireless communication system, and more particularly, to a method and apparatus for transmitting a discovery signal in a wireless communication system.

### BACKGROUND ART

Wireless communication systems have been widely deployed in order to provide various types of communication services including voice or data. In general, a wireless communication system is a multiple access system that can support communication with multiple users by sharing available system resources (a bandwidth, transmission power, etc.) among the multiple users. Examples of the multiple access system include Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

### DISCLOSURE

### Technical Problem

An object of the present invention devised to solve the conventional problem is to provide a method and apparatus for efficiently transmitting a discovery signal in a wireless communication system. Another object of the present invention is to provide a channel format, a signal process, and an apparatus for efficiently transmitting a discovery signal. Another object of the present invention is to provide a method and apparatus for efficiently allocating resources for transmission of a discovery signal.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In an aspect of the present invention, a communication method of a terminal supporting multiple Radio Access Technologies (RATs) includes communicating first data with a Base Station (BS), receiving, from a first Access Point (AP) of a plurality of APs, first information indicating the presence of the first AP, and communicating second data using the first AP. The first information is received in a first resource corresponding to at least part of radio resources available to the BS, the terminal and the BS may communicate using a first RAT, and the terminal and the first AP may communicate using a second RAT.

The first data may be communicated in a resource other than the first resource among the radio resources.

When the first data is transmitted in the first resource, the first data may be communicated in a predetermined size or a smaller size.

The communication method may further include transmitting a probe request frame after receiving the first information to the first AP, and receiving a probe response frame from the first AP.

If a plurality of BSs exist, the first resource may be at least part of radio resources used commonly in the plurality of BSs.

The first RAT may be World interoperability for Microwave Access (WiMAX) and the second RAT may be Wireless Fidelity (WiFi).

In another aspect of the present invention, a communication method of an AP includes transmitting, to a terminal communicating first data with a BS, first information indicating the presence of the AP, and communicating second data with the terminal. The first information is transmitted in a first resource corresponding to at least part of radio resources available to the BS, the terminal and the BS may communicate using a first RAT, and the terminal and the AP may communicate using a second RAT.

The first data may be communicated in a resource other than the first resource among the radio resources.

When the first data is transmitted in the first resource, the first data may be communicated in a predetermined size or a smaller size.

The communication method may further include receiving a probe request frame from the terminal after transmitting the first information, and transmitting a probe response frame in response to the probe request frame.

In another aspect of the present invention, a terminal supporting multiple RATs includes a transceiver module configured to communicate first data with a BS and to receive, from a first AP of a plurality of APs, first information indicating the presence of the first AP, and a processor configured to control communication of second data using the first AP. The first information is received in a first resource corresponding to at least part of radio resources available to the BS, the terminal and the BS communicate using a first RAT, and the terminal and the first AP communicate using a second RAT\.

The first data may be communicated in a resource other than the first resource among the radio resources.

When the first data is transmitted in the first resource, the first data may be communicated in a predetermined size or a smaller size.

When the first information is received, the processor may control the transceiver module to transmit a probe request frame to the first AP, and the transceiver module may receive a probe response frame from the first AP.

If a plurality of BSs exist, the first resource may be at least part of radio resources used commonly in the plurality of BSs.

The first RAT may be WiMAX and the second RAT may be WiFi.

In another aspect of the present invention, an AP includes a transceiver module configured to transmit, to a terminal communicating first data with a BS, first information indicating the presence of the AP and to communicate second data with the terminal, and a processor configured to control transmission of the first information in a first resource corresponding to at least part of total resources available to the BS. The terminal and the BS may communicate using a first RAT, and the terminal and the AP may communicate using a second RAT.

### Advantageous Effects

According to the present invention, a method and apparatus for efficiently transmitting a discovery signal in a wireless communication system can be provided. Furthermore, a channel format, a signal process, and an apparatus for efficiently transmitting a discovery signal can be provided.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 illustrates an exemplary multi-Radio Access Technology (RAT) system;

FIG. 2 illustrates an exemplary operation of a multi-RAT system;

FIG. 3 illustrates a specific example of Basic Service Sets (BSSs) classified according to use or non-use of an Access Point (AP);

FIG. 4 illustrates an example of data transmission and reception between a Base Station (BS) and a device in an AP-based multi-RAT system;

FIG. 5 illustrates an exemplary configuration of a Wireless Local Area Network (WLAN) system;

FIG. 6 illustrates another exemplary configuration of a WLAN system;

FIG. 7 illustrates active scanning;

FIG. 8 illustrates passive scanning;

FIG. 9 illustrates an example of conducting communication by selecting a BS and an AP in a Mobile Station (MS) in a communication system using heterogeneous networks according to the present invention;

FIG. 10 illustrates an exemplary communication method of an MS in a communication system using heterogeneous networks, which includes a plurality of BSs according to the present invention;

FIG. 11 illustrates an exemplary communication method of an MS in a communication system using heterogeneous networks, which includes a plurality of APs according to the present invention; and

FIG. 12 is a block diagram of an MS and a BS to which the present invention is applied.

### BEST MODE FOR CARRYING OUT THE INVENTION

Techniques as set forth below are applicable to various multiple access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications/General Packet Radio Service/Enhanced Data Rates for GSM Evolution (GSM/GPRS/EDGE). OFDMA may be implemented as a radio technology such as Institute of Electrical and Electronics Engineers (IEEE) 802.16 (WiMAX), IEEE 802.20, Evolved-UTRA (E-UTRA) etc. UTRAN is a part of Universal Mobile Telecommunication System (UMTS). 3^{rd} Generation Partnership Project 3GPP) Long Term Evolution (LTE) is a part of Evolved-UMTS (E-UMTS) using E-UTRAN. 3GPP LTE employs OFDMA for Downlink (DL) and SC-FDMA for Uplink (UL). LTE-Advanced (LTE-A) is an evolution of 3GPP LTE. IEEE 802.16m is an evolution of IEEE 802.16e.

In the disclosure, the term “multi-Radio Access Technology (multi-RAT)” may be interchanged with many other terms such as “wireless communication scheme”.

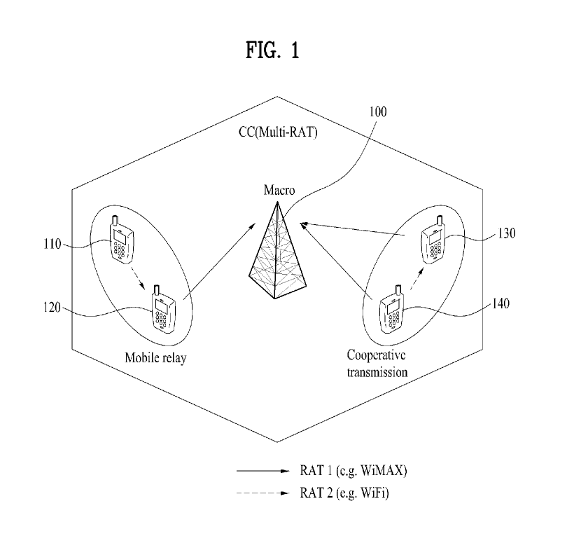

FIG. 1 illustrates an exemplary multi-RAT system.

Referring to FIG. 1, the multi-RAT system includes a Base Station (BS) 100 and a plurality of communication devices 110, 120, 130, and 140.

In FIG. 1, the communication devices 110, 120, 130, and 140 may include a source device that is connected to other communication devices and intends to communicate with a BS with the help of other communication devices, a cooperative device that acts as a coordinator to help the source device to communicate with the BS, and a candidate cooperative device other than a source device, which does not act as a cooperative device.

In the multi-RAT system, the plurality of communication devices 110, 120, 130, and 140 may build a cooperative system. In a cooperative multi-RAT system, a source device may transmit data to a BS, along with a cooperative device. Further, the source device may receive data from the BS, along with the cooperative device.

The plurality of devices may communicate with each other in a direct wireless communication scheme different from a direct wireless communication scheme between a BS and the plurality of devices. That is, data may be transmitted and received between the plurality of devices in a Wireless Local Area Network (WLAN) access scheme (e.g. Wi-Fi, etc.), whereas data may be transmitted and received between the BS and the plurality of devices in a mobile communication network access scheme (e.g. IEEE 802.16 (WIMAX), etc.).

For example, the plurality of devices may communicate directly with each other by IEEE 802.11 (Wi-Fi) or Bluetooth. On the other hand, each of the plurality of devices may communicate directly with the BS by IEEE 802.16 (WiMAX).

However, the present invention is not limited the specific communication schemes. Rather, the BS and the plurality of devices may communicate with one another in the same wireless communication scheme.

Referring to FIG. 1, the source device 140 may transmit data together with the cooperative device 130 to the BS 100 in the cooperative multi-RAT system. In this manner, a communication device may transmit data efficiently and thus has excellent performance. In addition, each device may enhance throughput through the cooperative multi-RAT system and the power consumption of each device may be reduced through cooperative data communication.

In the cooperative multi-RAT system, a source device may transmit data to a BS through a cooperative device. Furthermore, the source device may receive data from the BS through the cooperative device.

Referring to FIG. 1, the source device 110 may transmit data to the BS 100 through the cooperative device 120 in the cooperative multi-RAT system. Since a communication device may transmit data efficiently in this manner, degradation of system performance may be prevented.

While it has been described in FIG. 1 that a source device transmits data to a BS through a cooperative device by way of example, the same thing may apply to a case where the BS receives data from the source device.

If different data is transmitted, the source devices 110 and 140 may become cooperative devices or neighbor devices that do not participate in data transmission and the cooperative devices 120 and 130 may also become source devices or neighbor devices that do not participate in data transmission in FIG. 1.

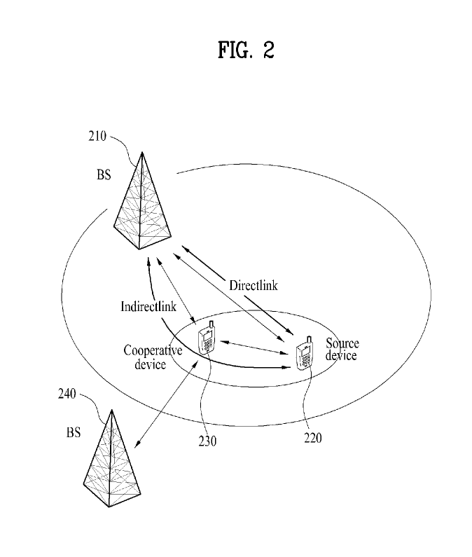

FIG. 2 illustrates an exemplary operation of a multi-RAT system.

Referring to FIG. 2, the multi-RAT system includes a BS 210 and a plurality of communication devices 220 and 230.

In the multi-RAT system, the plurality of communication devices 220 and 230 may build a cooperative system by a radio technology such as IEEE 802.11 (Wi-Fi).

In general, each of the plurality of communication devices 220 and 230 may transmit or receive data directly to or from the BS 210 by a radio technology such as IEEE 802.16 (WiMAX).

If the current communication quality of the source device 220 gets poor rapidly, the source device 220 may transmit data to the BS 210 indirectly through the cooperative device 230. The source device 220 may receive data from the BS 210 indirectly through the cooperative device 230.

If the cooperative device 230 has a capability of accessing an external network (e.g. the Internet), the cooperative device 230 may transmit data of the source device 220 to a BS 240 of the external network. Further, the cooperative device 230 may receive data for the source device 220 through the BS 240 of the external network. It is obvious that the above-described indirect communication and direct communication may apply herein.

Therefore, since a communication device may conduct indirect data communication with a BS with the aid of a cooperative device having an excellent communication quality as well as direct data communication with the BS in a multi-RAT system, degradation of system performance may be prevented and efficient data communication may be conducted.

For data transmission and reception through cooperation among a plurality of communication devices in the multi-RAT system, an information exchange procedure is required as a pre-procedure.

An information exchange procedure between a BS and a plurality of communication devices may be performed largely in four steps in the multi-RAT system: a general network entry step, a negotiation step for cooperation of a plurality of communication devices, a step of searching for neighbor devices and selecting a cooperative device from among detected neighbor devices by a source device, and a step of connecting to the selected cooperative device by the source device.

Meanwhile, cooperative communication of a plurality of communication devices in the multi-RAT system may be classified into infrastructure Basic Service Set (BSS) and Independent BSS (IBSS) depending on whether an AP is used or not.

An AP is an attachment point between a BS and a plurality of terminals in the multi-RAT system. The AP may also be referred to as a mutual attachment point. For example, the AP is a mediator that connects a wired LAN to a WLAN.

Although an AP may have many other appellations, the term “AP” is used herein, for the convenience of description.

If an AP is used in the multi-RAT system, a point-to-point function may be provided, which connects terminals at two locations and enables the terminals to communicate with each other.

Besides the point to point function, a point to multi-point function may be provided, which connects a plurality of terminals to one another simultaneously and thus enables mutual communication among the plurality of terminals.

In addition, as an AP is connected to a BS and another AP wirelessly, the AP may provide a repeater function by extending data communication to a wireless area. That is, an AP designated as a repeater may provide connectivity to a BS, while communicating with another AP.

When an AP is connected to a plurality of terminals that may exchange signals wiredly or through a short-range communication network, the AP may provide a wireless client function that enables wireless signal exchange.

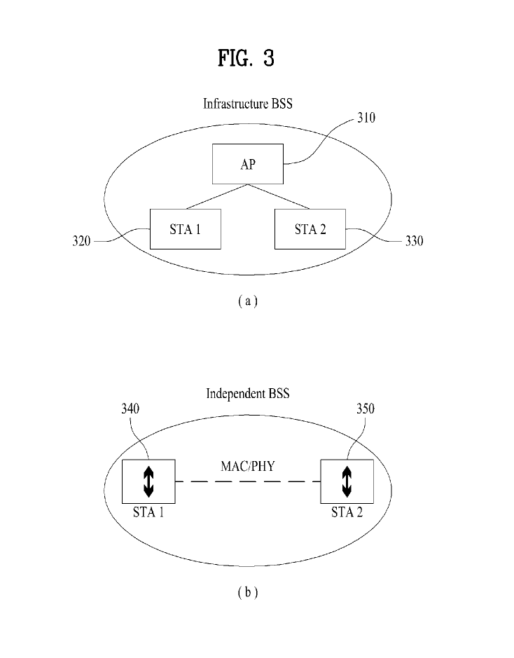

FIG. 3 illustrates a specific example of BSSs classified according to use or non-use of an AP.

FIG. 3(a) illustrates an example of an infrastructure BSS.

In an infrastructure BSS, a plurality of Stations (STAs) communicate through an AP.

A multi-RAT system may include a plurality of APs and there may exist a plurality of STAs around each of the APs.

FIG. 3(b) illustrates an example of an IBSS.

In an IBSS, a plurality of STAs are connected to one another directly.

The above description covers all of a case where a plurality of STAs are located within the service coverage of each of a plurality of APs, a case where a plurality of STAs are connected wirelessly within the service coverage of each of a plurality of APs, and a case where a plurality of STAs are detected in the service coverage of each of a plurality of APs. That is, if an STA and an AP are mutually associated, an IBSS may be configured.

However, the following description will be given based on the assumption that each STA is connected to an AP and forms an infrastructure BSS, for the sake of convenience.

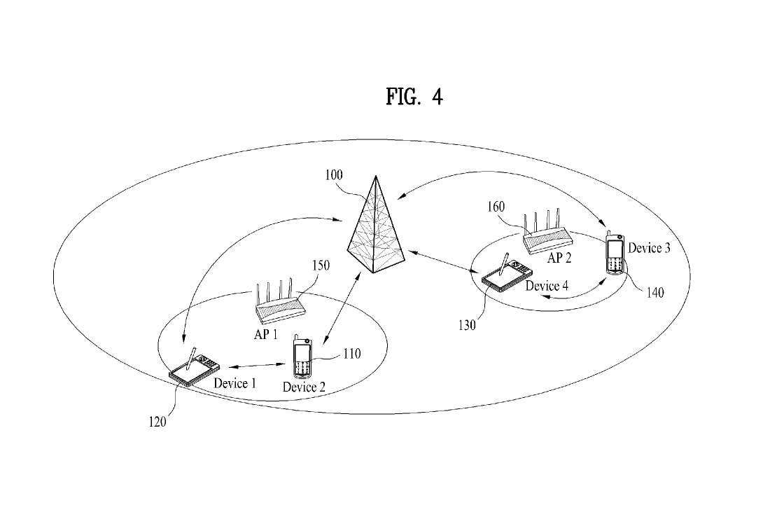

With reference to FIG. 4, a Client Cooperation (CC) operation in an infrastructure BSS will be described in more detail.

FIG. 4 illustrates an example of data transmission and reception between a BS and a device in an AP-based multi-RAT system.

Referring to FIG. 4, a first AP 150 (AP1) and a second AP 160 (AP2) are included in the multi-RAT system.

A first device 110 (Device 1) and a second device 120 (Device 2) are located near to the first AP 150 and the first and second devices 110 and 120 may conduct data communication with a BS 100, for CC.

A third device 130 (Device 3) and a fourth device 140 (Device 4) are located near to the second AP 160 and the third and fourth devices 130 and 140 may conduct data communication with the BS 100, for CC.

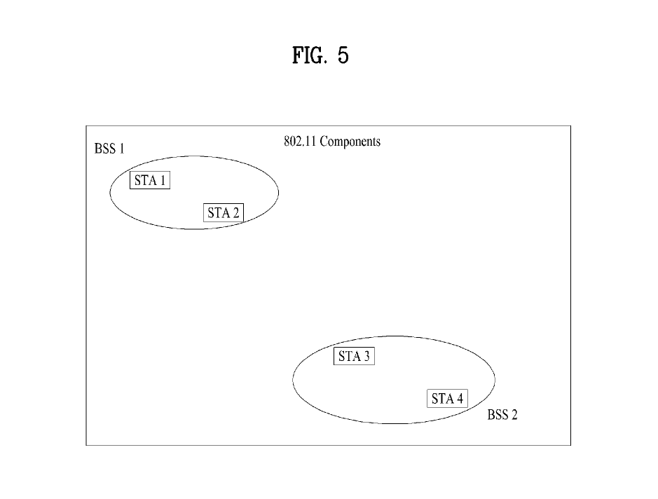

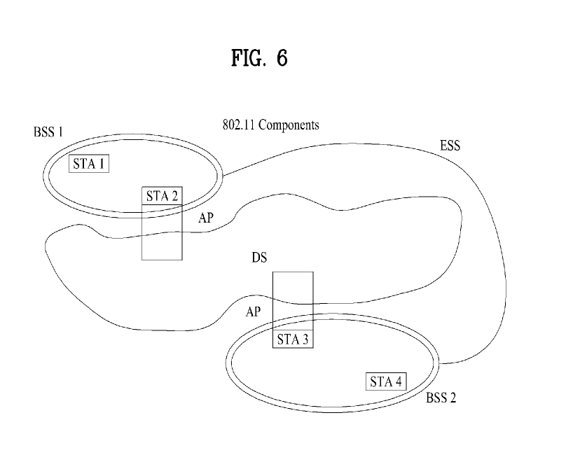

With reference to FIGS. 5 and 6, a general configuration of a WLAN system will be described below.

FIG. 5 illustrates an exemplary configuration of a WLAN system.

Referring to FIG. 5, the WLAN system includes at least one BSS. The BSS is a set of STAs that may communicate with each other by successful synchronization.

An STA is a logical entity including a physical layer interface for a Medium Access Control (MAC) layer and a Wireless Medium (WM). The STA may be an AP or a non-AP STA. Among STAs, a portable terminal manipulated by a user is a non-AP STA. An STA usually refers to a non-AP STA. The term non-AP STA may be replaced with Wireless Transmit/Receive Unit (WTRU), User Equipment (UE), Mobile Station (MS), mobile terminal, mobile subscriber unit, etc.

An AP is an entity that connects an associated STA to a Distribution System (DS) through a WM. The AP may be interchangeably used with a Base Station (BS), a Node B, a Base Transceiver System (BTS), a site controller, etc.

There are two types of BSSs, infrastructure BSS and IBSS.

A BSS illustrated in FIG. 5 is an IBSS. The IBSS refers to a BSS without an AP. Because the IBSS does not include an AP, the IBSS is not allowed to be connected to a DS and thus forms a self-contained network.

FIG. 6 illustrates another configuration of a WLAN system.

A BSS illustrated in FIG. 6 is an infrastructure BSS. The infrastructure BSS includes at least one STA and at least one AP. Basically, communication is conducted between non-AP STAs via an AP in the infrastructure BSS. However, if a direct link is established between non-AP STAs, the non-AP STAs may communicate with each other directly.

As illustrated in FIG. 6, a plurality of infrastructure BSSs may be interconnected via a DS. A plurality of BSSs connected via a DS is called an Extended Service Set (ESS). STAs included in the ESS may communicate with each other and a non-AP STA may move from one BSS to another BSS within the same ESS, while communicating seamlessly.

A DS is a mechanism that connects a plurality of APs to one another. The DS is not necessarily a network. As long as it provides a distribution service, the DS is not limited to any specific form. For example, the DS may be a wireless network such as a mesh network or a physical structure that connects APs to one another.

A spectrum unused by an incumbent user is called white space which is available to an unlicensed user. To allow an STA to operate in the white space spectrum, it is necessary to provide a protection technique for an incumbent user, first of all. To protect an incumbent user, an STA or an AP should use only a channel unused by the incumbent user. A channel unused by the incumbent user and thus available to an unlicensed user is referred to as an available channel. A basic method for determining availability of a TV channel by an STA or an AP is spectrum sensing and acquisition of a TV channel schedule by accessing a DataBase (DB). The DB includes information about an incumbent user's schedule of using a specific channel at a specific position. Accordingly, to determine whether a TV channel is available, the STA or the AP should access the DB over the Internet and acquire information from the DB based on position information about the STA or the AP.

To access a network, an STA should search for a network that it may join. Before joining a wireless network, the STA should identify a compatible network. A process of identifying a network in a specific area is referred to as scanning.

Scanning may be classified into active scanning and passive scanning.

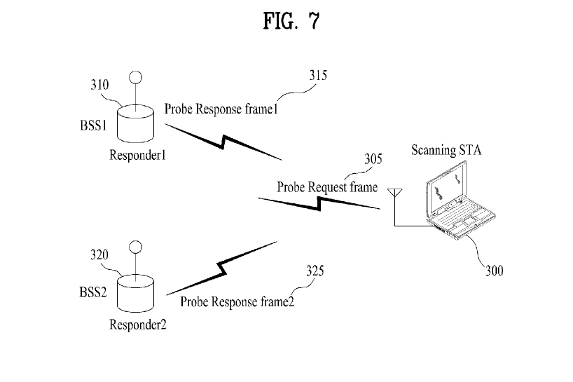

FIG. 7 illustrates active scanning.

An STA that performs active scanning transmits a probe request frame to discover an adjacent AP by moving from one channel after another and awaits reception of a response. A responder transmits a probe response frame in response to the probe request frame to the scanning STA. Herein, the responder is the last STA that transmits a beacon frame in a BSS of a scanned channel. Since an AP transmits a beacon frame in an infrastructure BSS, the AP is a responder. On the other hand, STAs sequentially transmit a beacon frame in an IBSS. Thus, a responder is not the same in the IBSS.

Referring to FIG. 7, upon receipt a probe request frame 305 from a scanning STA 300, a first responder 310 (Responder 1) and a second responder 320 (Responder 2) of a first BSS (BSS 1) transmit, to the scanning STA 300, a first probe response frame 315 (Probe Response Frame 1) and a second probe response frame 325 (Probe Response Frame 2), respectively. Upon receipt of the probe response frames 315 and 325, the scanning STA 300 stores BSS-related information included in the received probe response frames 315 and 325 and scans the next channel in the same manner by moving to the next channel.

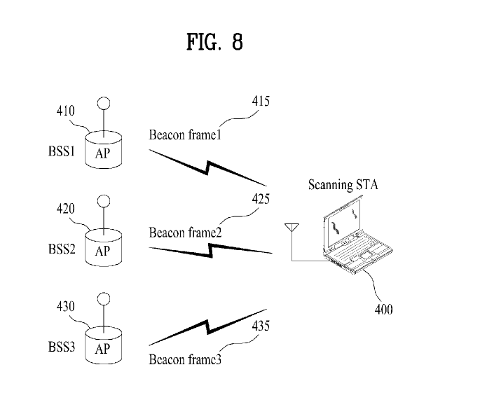

FIG. 8 illustrates passive scanning.

An STA that performs passive scanning awaits reception of a beacon frame, moving from one channel after another channel. The beacon frame is one of IEEE 802.11 management frames. The beacon frame is periodically transmitted so that a scanning STA may search for a wireless network and thus join the wireless network. In an infrastructure BSS, an AP is responsible for periodically transmitting a beacon frame.

Upon receipt of the beacon frame, the scanning STA stores BSS-related information included in the beacon frame and records information of a beacon frame on each channel, moving to another channel.

Referring to FIG. 8, if an STA 400 that performs passive scanning on a specific channel receives a first beacon frame 415 (Beacon Frame 1) from a first AP 410 (AP 1) of a first BSS (BSS 1) and a second beacon frame 425 (Beacon Frame 2) from a second AP 420 (AP 2) of a second BSS (BSS 2) but fails to receive a third beacon frame 435 (Beacon Frame 3) from a third AP 430 (AP 3) of a third BSS (BSS 3), the scanning STA 400 stores information indicating discovery of the two BSSs, BSS1 and BSS2 on the measured channels and moves to another channel.

Active scanning is advantageous over passive scanning because of a short delay and low power consumption.

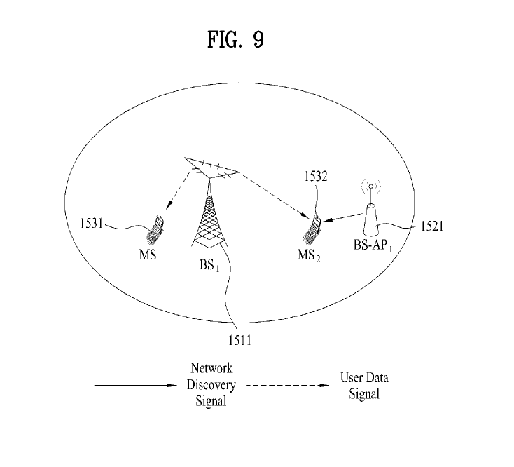

As described before, a plurality of communication systems may be used in combination in a multi-RAT system. In this case, a terminal performs a scanning procedure to switch between the plurality of communication systems. However, if the terminal performs the scanning procedure without prior information, the terminal may consume too much power. Moreover, if a target object for communication is remote from the terminal, the scanning procedure may be meaningless. This problem will be described in detail with reference to FIG. 9.

Referring to FIG. 9, a first MS 1531 (MS₁) and a second MS 1532 (MS₂) are connected to a first BS 511 (BS₁).

The first BS 1511 may want to offload data of the second MS 1532 to a first BS-AP 1521 (BS-AP₁).

Or the first BS 1511 may want the second MS 1532 to connect to the first BS-AP 1521 and communicate with the first BS-AP 1521.

In this case, to perform an operation intended by the first BS 1511 (i.e. offloading the data of the second MS 1532 to the first BS-AP 1521 or connection and communication between the second MS 1532 and the first BS-AP 1521), the second MS 1532 needs to determine whether the first BS-AP 1521 is near to the second MS 1532.

While the above description is given in the context of the second MS 1532, the same thing applies to the first MS 1531.

Therefore, the second MS 1532 performs the afore-described scanning procedure to acquire position information about the first BS-AP 1521.

However, if the first MS 1531 or the second MS 1532 performs the scanning procedure, power consumption may be too much. If the first BS-AP 1521 is remote from the MSs, the scanning procedure may be meaningless.

That is, if the first MS 1531 is remote from the first BS-AP 1521, the first MS 1531 reaches the conclusion that the first MS 1531 may not be connected to the first BS-AP 1521, as a result of the scanning procedure. Herein, the unnecessary scanning procedure leads to much power consumption.

Accordingly, the present invention provides a method for broadcasting a network discovery signal to MSs by an AP. For example, the first BS-AP 1521 may broadcast a network discovery signal in a resource area of the first BS 1511 in FIG. 14.

Hereinbelow, a detailed description will be given of a method for broadcasting a network discovery signal to MSs by an AP with reference to FIGS. 15 and 16.

### EMBODIMENT 1

In an embodiment of the present invention, a part of resources (e.g. a part of a time area or a frequency area) available to a macro BS is made empty and a network discovery signal is transmitted in the empty resource. If a plurality of macro BSs exist, the same resource areas of the macro BSs are made empty and a network discovery signal may be transmitted in the empty resources.

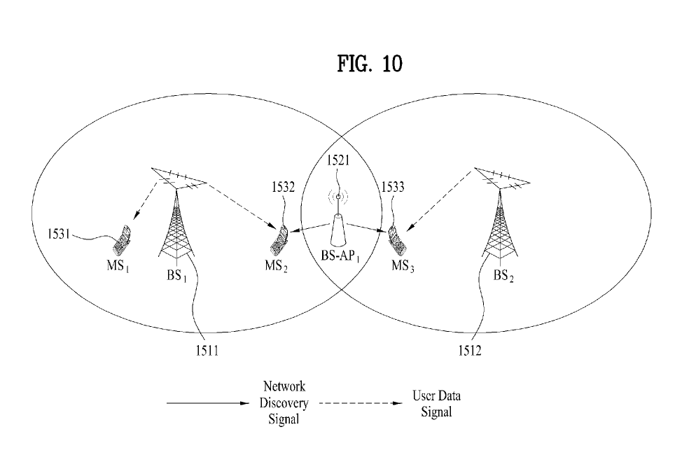

This will be described with reference to FIG. 10.

Referring to FIG. 10, the first MS 1531 and the second MS 1532 are connected to the first BS 1511. A third MS 1533 (MS₃) is connected to a second BS 1512 (BS₂).

The first BS 1511 may want to offload data of the second MS 1532 to the first BS-AP 1521 or to connect the second MS 1532 to the first BS-AP 1521, for communication,

Accordingly, the first BS 1511 may empty a part of resources and the first BS-AP 1521 may transmit a network discovery signal in the empty resource area.

The second BS 1512 may want to offload data of the third MS 1533 to the first BS-AP 1521 or to connect the third MS 1533 to the first BS-AP 1521, for communication.

To implement the above-described method of the present invention efficiently, the second BS 1512 may empty the same partial resource as that of the first BS 1511 and the first BS-AP 1521 may transmit network discovery signal in the empty resource area.

A method for emptying a part of resources (e.g. a part of a time area or a frequency area) available to a macro BS and transmitting a network discovery signal in the emptied resource area will be described in more detail.

Regarding emptying a partial resource area, a corresponding signal is not transmitted in a non-data area (e.g. an area carrying an LBS signal, a preamble transmission area, a midamble transmission area, etc. in IEEE 802.16m). Instead, a network discovery signal is transmitted in the non-data area.

This non-data signal is generally transmitted periodically. According to the proposed method, since the corresponding signal may not be available periodically, a longer period than the transmission period of the corresponding signal is preferably set.

Instead of data of an MS, a network discovery signal may be transmitted in a specific data resource area.

That is, data of an MS may be generated according to a conventional sub-channelization rule and then a network discovery signal may be transmitted by puncturing an area that will carry the network discovery signal.

For the sub-channelization to generate the data of the MS, a resource other than the area carrying the network discovery signal may be used.

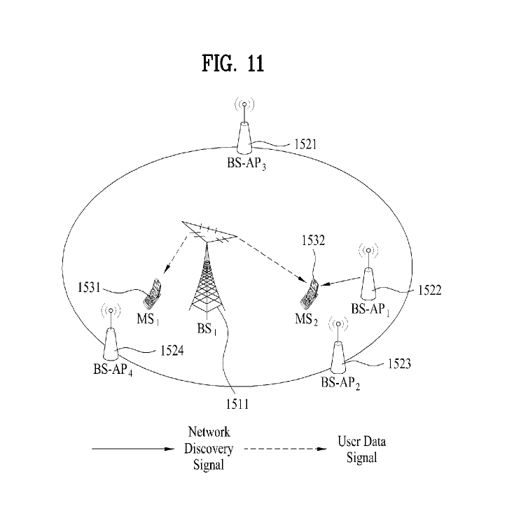

Meanwhile, a case where a plurality of APs announce their presence as illustrated in FIG. 11 may be considered. That is, the first BS-AP 1521, a second BS-AP 1522 (BS-AP₂), a third BS-AP 1523 (BS-AP₃), and a fourth AP 1524 (BS-AP₄) may transmit network discovery signals to announce their presence to MSs.

If the first BS-AP 1521, the second BS-AP 1522, the third BS-AP 1523, and the fourth BS-AP 1524 have only to announce their presence, they may transmit the same network discovery signals in a single resource area.

The signals transmitted in the same resource area by the plurality of APs bring a macro diversity effect. Thus, since an MS receives the sum of the signals transmitted from the APs, the received signal may be stronger than a data signal received from the first BS 1511.

To prevent this problem, the MS may measure the strength of a network discovery signal. If the measured strength of the network discovery signal exceeds a predetermined signal strength, the MS may be prepared for offloading to another AP, that is, the MS may perform a scanning procedure.

Since signals transmitted in macro diversity (i.e. every BS-AP transmits the same signal) may be stronger than a signal that each BS-AP may provide, the signals may be overestimated relative to the signal that each BS-AP may provide.

Therefore, adjacent APs may transmit different network discovery signals or transmit a network discovery signal in different resource areas in the present invention.

### EMBODIMENT 2

In another embodiment of the present invention, an AP transmits a network discovery signal in a part of resources (e.g. a part of a time area or a frequency area) available to a macro BS, without emptying the partial resource area).

If a data signal received from the macro BS is too strong, an MS has difficulty in detecting a network discovery signal from the AP. Therefore, the macro BS may transmit a signal in the corresponding resource area by decreasing the strength of the signal to an appropriate value.

This will be described with reference to FIG. 10.

Referring to FIG. 10, it may be assumed that a data signal from the first BS is very strong.

In this case, it is difficult for the first MS 1531 and the second MS 1532 to detect a network discovery signal transmitted by the first BS-AP 1521. Thus, the first BS 1511 and the second BS 1512 may transmit signals in the corresponding resource area by appropriately reducing the strengths of the signals.

Since it is difficult to transmit a pilot signal or a reference signal with which to estimate a channel state between an AP and an MS due to detection of a network discovery signal in this embodiment, it is preferred to transmit a signal detectable without channel estimation as the network discovery signal.

For example, if a channel does not change much in a transmission resource area, it may be determined whether a specific sequence has been transmitted by a method such as correlation. Therefore, the network discovery signal may be transmitted by selecting a sequence having a good correlation characteristic.

As illustrated in FIG. 11, the case where a plurality of APs announce their presence may be considered. That is, the first BS-AP 1521, the second BS-AP 1522, the third BS-AP 1523, and the fourth BS-AP 1524 may transmit network discovery signals to announce their presence to MSs.

If the first BS-AP 1521, the second BS-AP 1522, the third BS-AP 1523, and the fourth BS-AP 1524 have only to announce their presence, they may transmit the same network discovery signals in a single resource area.

The signals transmitted in the same resource area by the plurality of APs bring a macro diversity effect. Thus, since an MS receives the sum of signals transmitted from the APs, the received signal may be stronger than a data signal received from the first BS 1511.

To prevent this problem, the MS may measure the strength of a network discovery signal. If the measured strength of the network discovery signal exceeds a predetermined signal strength, the MS may be prepared for offloading to another AP, that is, the MS may perform a scanning procedure.

Since signals transmitted in macro diversity (i.e. every BS-AP transmits the same signal) may be stronger than a signal that each BS-AP may provide, the signals may be overestimated relative to the signal that each BS-AP may provide.

Therefore, adjacent APs may transmit different network discovery signals or transmit a network discovery signal in different resource areas in the present invention.

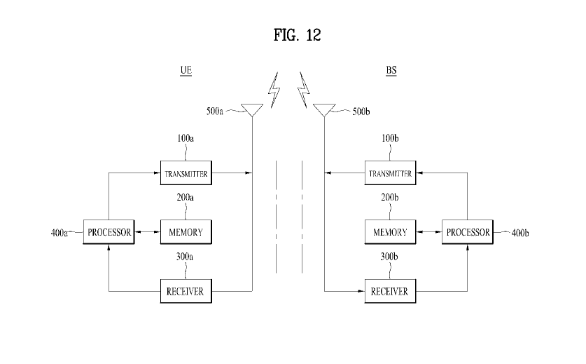

FIG. 12 is a block diagram of an MS and a BS to which the present invention is applied. The MS acts as a transmitter on an uplink and as a receiver on a downlink. The BS acts as a receiver on an uplink and as a transmitter on a downlink.

Referring to FIG. 12, each of the MS and the BS includes an antenna 500a or 500b for receiving information, data, a signal, or a message, a transmitter 100a or 100b for transmitting information, data, a signal, or a message by controlling the antenna 500a or 500b, a receiver 300a or 300b for receiving information, data, a signal, or a message by controlling the antenna 500a or 500b, and a memory 200a or 200b for storing various types of information in a wireless communication system, temporarily or permanently. Each of the MS and the BS further includes a processor 400a or 400b that is functionally connected to the components such as the transmitter, the receiver, and the memory and that is configured to control each component.

In the MS, the transmitter 100a, the receiver 300a, the memory 200a, and the processor 400a may be implemented as independent components on separate chips, or two or more of the transmitter 100a, the receiver 300a, the memory 200a, and the processor 400a may be implemented on a single chip. The transmitter and the receiver may be incorporated as a single transceiver in the MS or the BS.

The antennas 500a and 500b transmit signals generated from the transmitters 100a and 100b to the outside of the MS and the BS or receive external signals and provide the received signals to the receivers 300a and 300b. The antenna 500a and 500b are referred to as antenna ports. An antenna port may correspond to one physical antenna or a combination of a plurality of physical antennas. If a transceiver supports Multiple Input Multiple Output (MIMO) in which data is transmitted or received through a plurality of antennas, the transceiver may be connected to two or more antennas.

The processors 400a and 400b generally provide overall control to the components or modules of the MS and the BS, respectively. Particularly, the processors 400a and 400b may perform various control functions for implementing the present invention, a MAC frame conversion control function according to service characteristics and a propagation environment, a power saving mode function for controlling an idle-mode operation, a handover function, an authentication and encryption function, etc. The processors 400a and 400b may be called controllers, microcontrollers, microprocessors, or microcomputers. Meanwhile, the processors 400a and 400b may be configured by hardware, firmware, software, or a combination thereof.

In a hardware configuration, the processors 400a and 400b may include Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc. which are configured to implement the present invention.

In a firmware or software configuration, the firmware or the software may be configured to include a module, a procedure, a function, etc. performing the above-described functions or operations of the present invention. The firmware or the software configured to implement the present invention may be provided in the processors 400a and 400b, or may be stored in the memories 200a and 200b and executed by the processors 400a and 400b.

The transmitters 100a and 100b encode and modulate a transmission signal or transmission data scheduled by the processors 400a and 400b or schedulers connected to the processors 400a and 400b in a predetermined coding and modulation scheme and then output the coded and modulated signal or data to the antennas 500a and 500b. The transmitters 100a and 100b and the receivers 300a and 300b of the MS and the BS may be configured differently according to procedures for processing a transmission signal and a received signal.

The memories 200a and 200b may store programs for processing and controlling in the processors 400a and 400b and may temporarily store input/output information. The memories 200a and 200b may be used as buffers. The memories 200a and 200b may be configured using a flash memory type, a hard disk type, a multimedia card micro type, a card type memory (e.g. a Secure Digital (SD) or eXtreme Digital (XD) memory), a Random Access memory (RAM), a Static Random Access Memory (SRAM), a Read Only Memory (ROM), an Electrically Erasable Programmable Read-Only Memory (EEPROM), a Programmable Read Only Memory (PROM), a magnetic memory, a magnetic disk, an optical disk, etc.

### INDUSTRIAL APPLICABILITY

The method and apparatus for transmitting a discovery signal in a wireless communication system are applicable to various wireless communication systems such as 3GPP LTE-A, IEEE 802, etc.

1-17. (canceled)

18. A communication method of a terminal supporting multiple Radio Access Technologies (RATs), the communication method comprising:
communicating first data with a Base Station (BS);
receiving, from a first Access Point (AP) of a plurality of APs, first information indicating the presence of the first AP; and
communicating second data using the first AP,
wherein the first information is received in a first resource corresponding to at least part of radio resources available to the BS, the terminal and the BS communicate using a first RAT, and the terminal and the first AP communicate using a second RAT.

19. The communication method according to claim 18, wherein the first data is communicated in a resource other than the first resource among the radio resources.

20. The communication method according to claim 18, wherein when the first data is transmitted in the first resource, the first data is communicated in a predetermined size or a smaller size.

21. The communication method according to claim 18, further comprising:
transmitting a probe request frame after receiving the first information; and
receiving a probe response frame from the first AP.

22. The communication method according to claim 18, wherein if a plurality of BSs exist, the first resource is at least part of radio resources used commonly in the plurality of BSs.

23. The communication method according to claim 18, wherein the first RAT is World interoperability for Microwave Access (WiMAX) and the second RAT is Wireless Fidelity (WiFi).

24. A communication method of an Access Point (AP), comprising:
transmitting, to a terminal communicating first data with a Base Station (BS), first information indicating the presence of the AP; and
communicating second data with the terminal,
wherein the first information is transmitted in a first resource corresponding to at least part of radio resources available to the BS, the terminal and the BS communicate using a first Radio Access Technology (RAT), and the terminal and the AP communicate using a second RAT.

25. The communication method according to claim 24, wherein the first data is communicated in a resource other than the first resource among the radio resources.

26. The communication method according to claim 24, wherein when the first data is transmitted in the first resource, the first data is communicated in a predetermined size or a smaller size.

27. The communication method according to claim 24, further comprising:
receiving a probe request frame from the terminal after transmitting the first information; and
transmitting a probe response frame in response to the probe request frame.

28. A terminal supporting multiple Radio Access Technologies (RATs), the terminal comprising:
a transceiver module configured to communicate first data with a Base Station (BS) and to receive, from a first Access Point (AP) of a plurality of APs, first information indicating the presence of the first AP; and
a processor configured to control communication of second data using the first AP,
wherein the first information is received in a first resource corresponding to at least part of radio resources available to the BS, the terminal and the BS communicate using a first RAT, and the terminal and the first AP communicate using a second RAT.

29. The terminal according to claim 28, wherein the first data is communicated in a resource other than the first resource among the radio resources.

30. The terminal according to claim 28, wherein when the first data is transmitted in the first resource, the first data is communicated in a predetermined size or a smaller size.

31. The terminal according to claim 28, wherein when the first information is received, the processor is configured to control the transceiver module to transmit a probe request frame, and the transceiver module is configured to receive a probe response frame from the first AP.

32. The terminal according to claim 28, wherein if a plurality of BSs exist, the first resource is at least part of radio resources used commonly in the plurality of BSs.

33. The terminal according to claim 28, wherein the first RAT is World interoperability for Microwave Access (WiMAX) and the second RAT is Wireless Fidelity (WiFi).
